(19) United States
(12) Patent Application Publication
(10) Pub. No.: US 2004/0034784 A1
(43) Pub. Date: Feb. 19, 2004

(54) System and method to facilitate separate cardholder and system access to resources controlled by a smart card

(76) Inventors: Dominique Louis Joseph Fedronic, Belmont, CA (US); Eric F. Le Saint, Fremont, CA (US)

Correspondence Address: STEVENS, DAVIS, MILLER & MOSHER, L.L.P., 1615 L Street, N.W., Suite 850, Washington, DC, 20036, US

(21) Appl. No.: 10/218,665

(22) Filed: Aug. 15, 2002

(51) Int. Cl. H04L 9/32

(52) U.S. Cl. 713/186; 713/202

(57) ABSTRACT

This invention provides a mechanism, which allows a user's personal identification number (PIN) to operate independently from a biometric authentication system. This improvement reduces the administrative burden of having to keep a user's PIN synchronized with the PIN used to access the user's smart card following successful biometric authentication. The first embodiment of the invention incorporates a cryptographic interface, which bypasses the PIN entry and allows the biometric authentication system to directly access card resources. The second embodiment of the invention provides a second system PIN having greater bit strength than the cardholder PIN. Both embodiments of the invention retrieve secrets (either a cryptographic key or system PIN) from a biometric database by comparing a processed biometric sample with known biometric templates. The biometric authentication system incorporates a client-server architecture, which facilitates multiple biometric authentications.

### FIELD OF INVENTION

The present invention relates to a data processing system and method for accessing a security token using a second identifier assigned to a biometric authentication system.

### BACKGROUND OF INVENTION

Biometric data is increasingly being used for authentication and other purposes. When combined with the features available in smart cards, a reasonably robust authentication system results which simplifies access to a wide variety of computer-based services. For example, a typical user has a number of usernames and passwords that have to memorized in order to gain access to each specific service. By storing the usernames and passwords in a smart card, the cardholder only needs to remember a personal identification number or PIN. By adding biometrics to the authentication process, the PIN entry procedure is replaced with a biometric scan that retrieves and enters the PIN directly into the smart card. There are two solutions in the current art that supports PIN retrieval and the current generation of ISO-7616-4 compliant smart cards as follows.

The first solution involves storing a PIN locally on a client and using a current biometric sample to retrieve and send the user's PIN to the smart card. The biometric sample is compared locally with an established biometric template associated with the cardholder. This solution is the least secure since both the user's biometric template and PIN temporarily resides on the local client. An example of this solution is disclosed in U.S. Pat. No. 6,011,858 to Stock, et al.

The second solution involves storing the cardholder's PIN in a database on a server, which is retrievable by matching the cardholder's biometric sample to a previously enrolled biometric template of the cardholder. The retrieved PIN is then sent to the smart card, which allows access to the cards' internal resources. This solution is more secure than the local client solution but is still dependent on the cardholder's PIN. If a cardholder were to change his or her PIN, the server-based solution would no longer allow the use of biometrics to gain access to the smart card.

At a minimum, the cardholder would need to reenroll his or her PIN in order to recover biometric access. This adds to the system administration burden and causes delays and inconvenience to the cardholder. Lastly, it is also possible that a cardholder could repudiate transactions by claiming that his or her smart card were compromised by persons having access to the PIN at the server end. The latter situation is mitigated considerably by enciphering the stored PIN, however, the argument is still valid since most PINs are usually 4 digits (32 bits) in length as a compromise between security and the ability of the cardholder to memorize the PIN.

Thus it would be highly desirable to have a biometric authentication system, which incorporates the robust features inherent in the server-based solution described above but operates independently of the cardholder's PIN.

### SUMMARY OF INVENTION

This invention provides a mechanism, which allows a user's personal identification number (PIN) associated with a smart card to operate independently from a biometric authentication system. This improvement reduces the administrative burden of having to keep a user's PIN synchronized with the PIN used to access the user's smart card following successful biometric authentication. A smart card as used herein refers to a microprocessor-based memory card.

Two embodiments of the invention are disclosed. The first embodiment retrieves a server key from a database associated with a biometric authentication server. A comparison is performed following processing of a user's biometric data, which is compared to a database of biometric templates. A successful match retrieves the server key associated with the user's smart card. The server key may be a distinct symmetric key, a master key that is diversified to obtain a symmetric server key or a public key counterpart to a card private key.

Once the server key is available a challenge/response protocol is initiated which authenticates the server to the smart card. Access to card resources is permitted following successful authentication. It should be noted that biometric authentications are generally used to authenticate cardholders to their smart cards as an alternative to remembering personal identification numbers (PINs). Additional authentications are typically performed between the smart card and the server, which utilize more robust cryptographic methods.

In the second embodiment of the invention, a system PIN preferably having bit strength of at least 64 bits (8 digits) is stored in both the smart card and in the biometric database. As before, the cardholders' biometric data is compared against a database of biometric templates. A match retrieves the record containing the server PIN and is sent to the smart card for comparison with the stored version of the system PIN. If a match is found, access is allowed to the card's internal resources.

Additional security enhancements include the use of secure messaging protocols between the smart card and the server and cryptographically protecting data stored in the biometric database.

### BRIEF DESCRIPTION OF DRAWINGS

FIG. 1—is a generalized block diagram illustrating the invention.

FIG. 2—is a detailed block diagram illustrating the input of biometric data and processing by a server based biometric processor.

FIG. 3—is a detailed block diagram illustrating the input of the processed result into a biometric database and records match against a preexisting biometric template.

FIG. 4A—is a detailed block diagram illustrating one embodiment of the invention where a challenge/response protocol is used to authenticate the cardholder to the smart card.

FIG. 4B—is a detailed block diagram illustrating a second embodiment of the invention where a third PIN is used to authenticate the cardholder to the smart card

FIG. 5—is a flowchart illustrating the steps involved in implementing the invention.

FIG. 5A—is a flowchart illustrating the authentication steps in the first embodiment of the invention.

FIG. 5B—is a flowchart illustrating the authentication steps in the second embodiment of the invention.

### DETAILED DESCRIPTION OF PREFERRED EMBODIMENT

This invention provides a mechanism, which allows a user's personal identification number (PIN) to operate independently from a biometric authentication system. This improvement reduces the administrative burden of having to keep a user's PIN synchronized with the PIN used to access the user's smart card following successful biometric authentication.

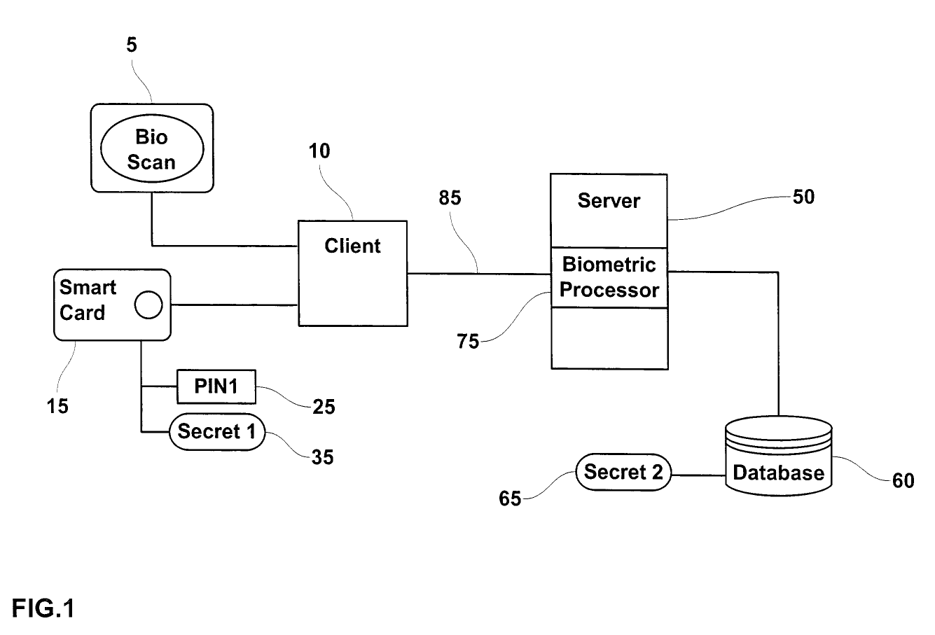

Referring to FIG. 1, a generalized system block diagram is depicted. In the basic common embodiment of the invention, a client 10 is locally and operatively connected to a biometric scanning device 5 and a user's smart card 15. The client is in processing communications 85 with a server 50.

The biometric scanning device 5 may include a fingerprint scanner, a retinal scanner, an iris scanner, a hand geometry scanner, a face recognition scanner, hand writing scanner or a voice pattern scanner. The biometric scanner 5 is used to obtain a biometric sample from a cardholder and transfer the biometric data to the client 10.

The smart card 15 includes standard libraries and cryptographic extensions that facilitate both publicly available symmetric and asymmetric cryptographic functions including the ability to perform challenge response authentications. The smart card has been personalized with a user's PIN (PIN1) 25 and includes a secret (Secret 1) 35 which allows access to card resources without requiring the user's PIN (PIN1) 25.

The card secret (Secret 1) 35 in the preferred embodiment of the invention is a symmetric key that is used to authenticate the server to the smart card. A symmetric key is preferred to minimize use of scarce memory storage and limited processing power available in the smart card. An asymmetric private key will provide equivalent functionality and is envisioned by the inventor as well. In a second embodiment of the invention, the card secret (Secret 1) is a second PIN, which is compared with a third PIN sent from the server. The choice of secret (PIN or cryptographic key) is dependent on the type of smart cards being deployed.

Open platform smart cards allow access to protected resources using a PIN, customized cryptographic protocols or both. Closed platform cards generally require a PIN to access protected resources. However, multiple PINs can be defined having equivalent card privileges and thus may be used with this invention as well.

The server 50 includes a biometric processor 75. The biometric processor provides greater biometric conditioning to improve recognition and false error discrimination. The results of the biometric processing are used to query a database 60 containing biometric template records.

The biometric template records are relationally associated with specific server secrets necessary to authenticate a user to his or her smart card. In the instant case, the server secret (Secret 2) 65 will be used to authenticate the user to his or her smart card. For purposes of example, it should be assumed that the user has already enrolled their particular biometric data and stored in a biometric template record of the biometric database.

In the preferred embodiment of the invention, the communications between the client and the server 85 is performed using a secure messaging protocol such as TCP/IP implementing transport layer security (TLS) including secure socket layer (SSL) encryption, IPSEC, etc.

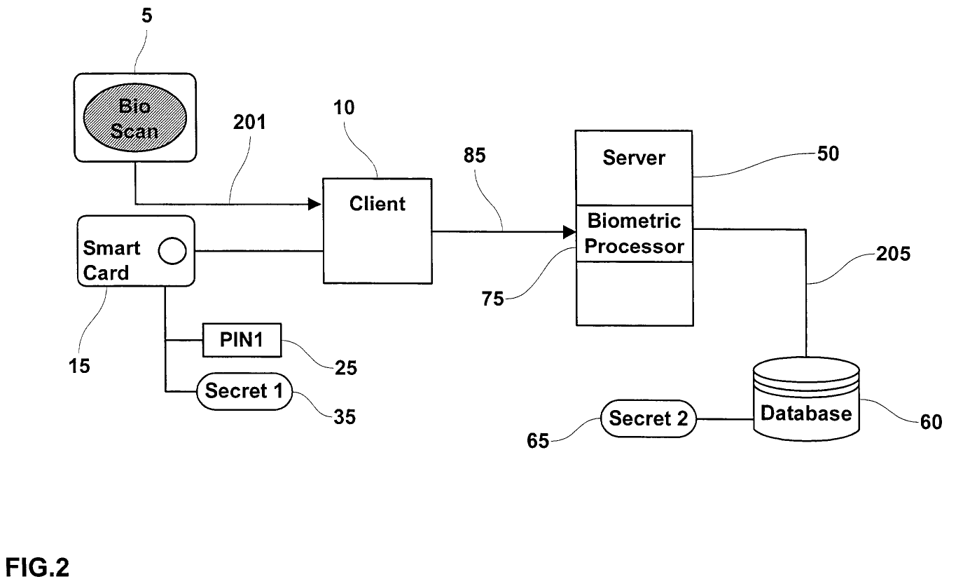

In FIG. 2, a cardholder has entered his or her biometric data into the biometric scanner 5. The biometric data is transferred 201 to the client and communicated 85 to the server 50. The biometric data is processed using the biometric processor 75 and the resulting biometric data used to query 205 the database 60 against existing biometric templates.

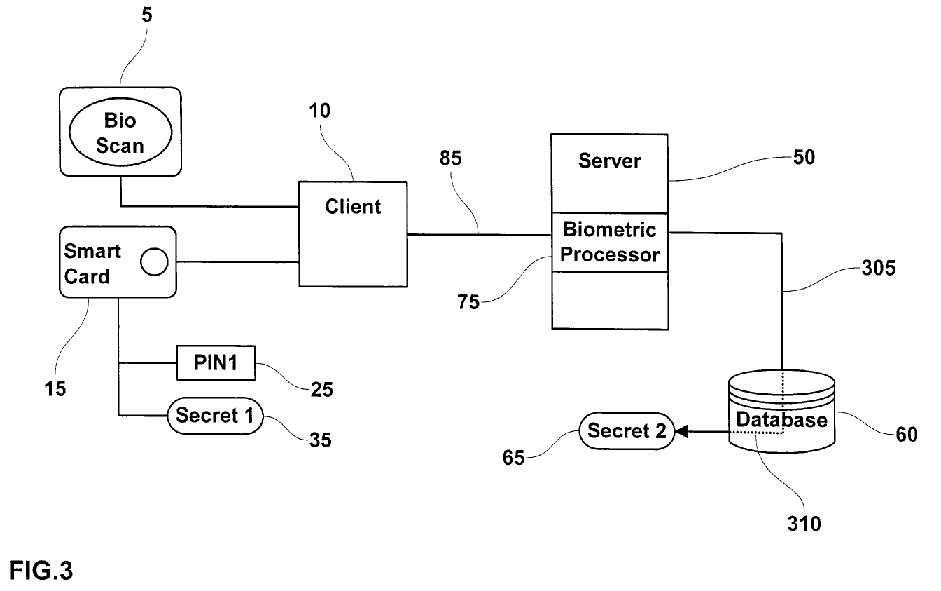

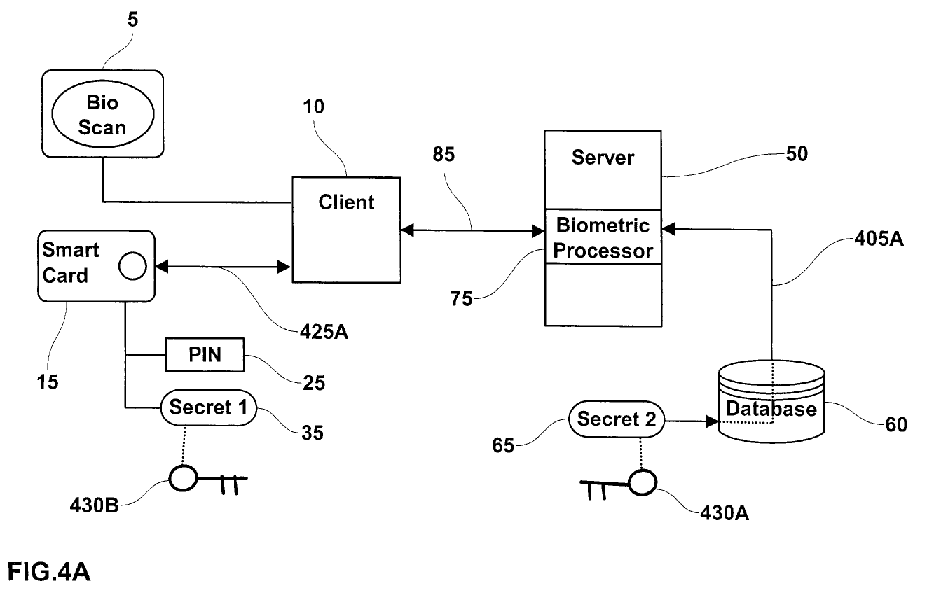

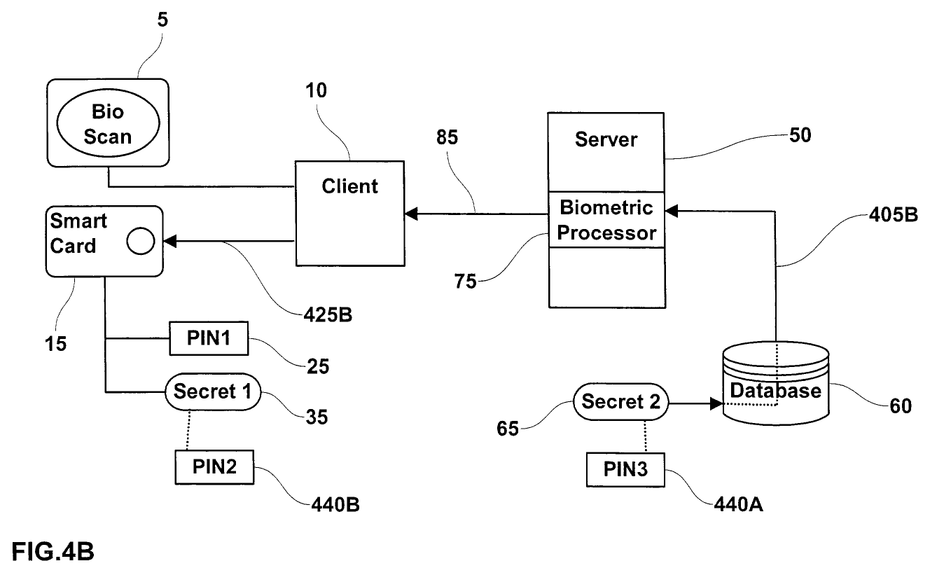

In FIG. 3, the database matches 310 a biometric template with the biometric data. The recording containing the biometric template is retrieved from the database and the secret contained therein used to authenticate the user to the smart card as described in FIGS. 4A and 4B.

In FIG. 4A, the server secret (Secret 2) 65 includes a symmetric cryptographic key 430A. The cryptographic key 430A may be a distinct card key or a master key, which is diversified to obtain the card key 430B based on a unique identifier supplied by the smart card during the authentication process.

The cryptographic key 430A is transferred 405A to the server where a challenge\response authentication protocol 425A is performed, which implicitly authenticates the user to the smart card. In another embodiment of the invention, the server cryptographic key 430A is the public key counterpart to the card private key 430B. An equivalent of the challenge\response protocol is employed using the asymmetric keys.

Referring to FIG. 4B, the second embodiment of the invention is shown where the server secret (Secret 2) 65 includes a server PIN (PIN3) 440A which is equal to a card PIN (PIN2) 440B but unrelated to the user PIN (PIN1) 25. In this embodiment of the invention, the server PIN (PIN3) 440A is transferred 405B from the database record and is sent 425B to the smart card 15 where it is compared with the card PIN (PIN2) 440B. A match implicitly authenticates the user to the smart card 15.

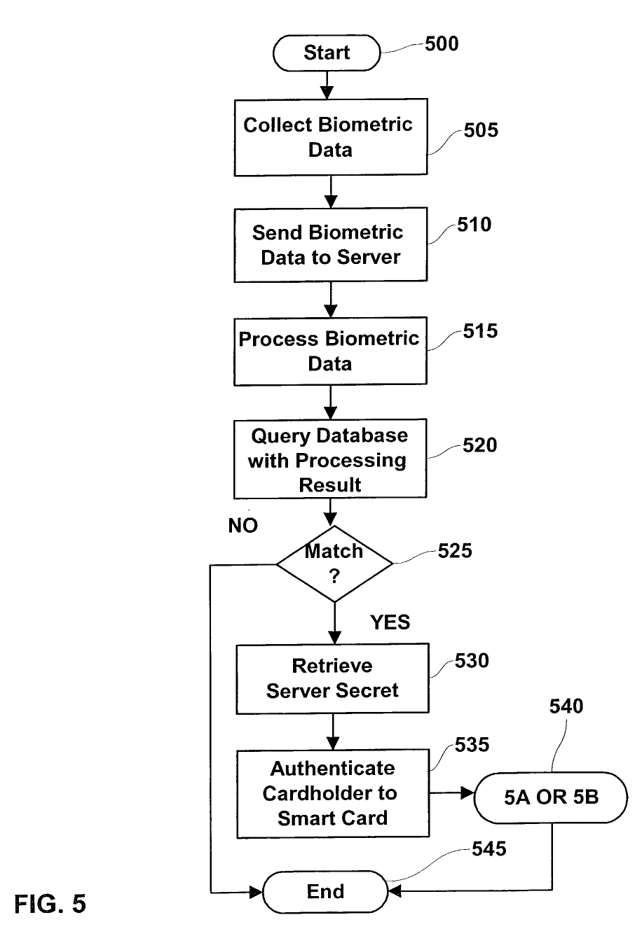

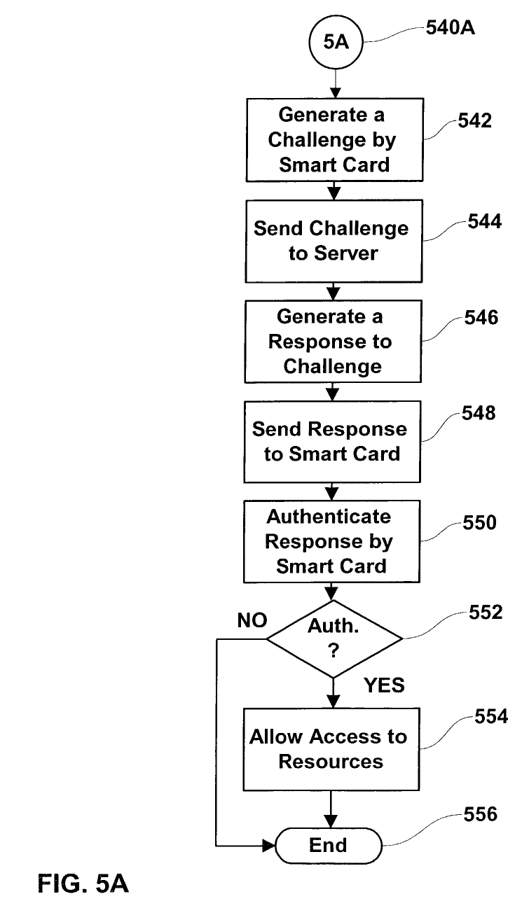

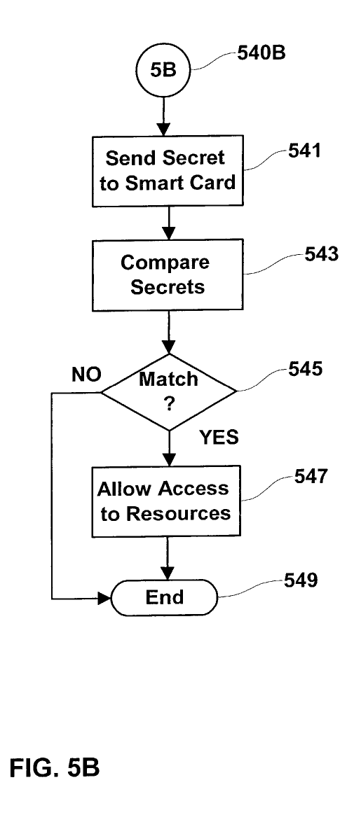

In FIG. 5, a flowchart is presented which provides the steps involved in implementing the invention. The process is initiated 500 by collecting a biometric sample from a cardholder 505. The biometric sample is sent to a server for processing 510. A biometric engine processes the biometric sample 515 and the result is used to query a database 520 of enrolled biometric templates. If no match is found 525 the authentication process ends 545 and the cardholder must either retry entering his or her biometric sample or notify a system administrator of the failed authentication.

If a biometric template record matches 525 that of the cardholder, a server secret is retrieved which is used to authenticate the cardholder to the smart card 535. The authentication process employed is dependent on the type of smart card 540. The more robust method is shown in FIG. 5A. This method may be implemented in open platform smart cards.

The authentication process continues 540A with a challenge being generated by the smart card 542. The challenge is typically a random number encrypted with a card key previously installed inside the smart card. The challenge is sent to the server 544. Depending on the counterpart server key, the challenge may include a unique identifier that is used to diversify a master key to generate an operable server key. A response is generated by decrypting the challenge using the server key 546, which is subsequently returned to the smart card 548.

The smart card authenticates the response by comparing the initial random number to the response 550. If no match is found 552 the authentication session ends 556. If successful 552, the cardholder is authenticated to the smart card and allowed to access the card resources 554 until his or her session ends 556.

In a second embodiment of the invention shown in FIG. 5B, the authentication process continues 540B by sending the retrieved secret to the smart card 541. In this embodiment of the invention, the retrieved secret is a system PIN established independently of the cardholder PIN. The smart card compares the received system PIN with the previously installed system PIN 543. If no match is found 545, the authentication session ends 549. If a match is found 545, the cardholder is authenticated to the smart card and allowed to access the card resources 547 until his or her session ends 549.

The foregoing described embodiments of the invention are provided as illustrations and descriptions. They are not intended to limit the invention to precise form described. In particular, it is contemplated that functional implementation of the invention described herein may be implemented equivalently in hardware, software, firmware, and/or other available functional components or building blocks. Other variations and embodiments are possible in light of above teachings, and it is not intended that this Detailed Description limit the scope of invention, but rather by the claims following herein.

What is claimed:

1. A system to facilitate separate cardholder and authority access to resources controlled by a smart card comprising:
a client operatively equipped with said smart card and a biometric sensor for input of biometric data associated with said cardholder,
said smart card including authentication means for at least preventing unauthenticated access to said resources and memory having operatively stored therein a first identifier associated with said cardholder holder and a token secret associated with a server,
said server including biometric data processing means, a biometric database and at least one record in said biometric database retrievable using a biometric result of said biometric data processing,
said at least one record including a biometric template associated with said cardholder and a server secret associated with said smart card.

2. The system according to claim 1 wherein a match between said biometric result and said biometric template retrieves said server secret.

3. The system according to claim 2 wherein said cardholder is authenticated to said smart card using said authentication means in concert with said token secret and said server secret.

4. The system according to claim 3 wherein said token secret is a first cryptographic key.

5. The system according to claim 4 wherein said authentication means includes a cryptographic algorithm compatible with said first cryptographic key.

6. The system according to claim 5 wherein said server secret includes a second cryptographic key compatible with said first cryptographic key.

7. The system according to claim 6 wherein said authentication means includes means for performing challenge\response authentications.

8. The system according to claim 3 wherein said authentication means includes a comparator.

9. The system according to claim 8 wherein said token secret includes a second identifier.

10. The system according to claim 9 wherein said server secret includes a third identifier.

11. The system according to claim 10 wherein said authentication means compares said second identifier and said third identifier and allows access to said resources if an exact match is found.

12. The system according to claim 11 wherein said first, second and third identifiers are personal identification numbers.

13. The system according to claim 12 wherein said first identifier and said second identifier are different.

14. The system according to claim 8 wherein said cardholder is authenticated to said smart card by said first identifier or said biometric result.

15. The system according to claim 1 wherein said biometric data includes at least a fingerprint, a handwriting scan, a retinal scan, an iris scan, a hand geometry scan, a face recognition scan, or a voice pattern scan.

16. The system according to claim 1 wherein said resources includes means for authenticating said smart card to said server.

17. The system according to claim 1 wherein said client and said server are in processing communications using a secure messaging protocol.

18. The system according to claim 17 wherein said client and said smart card are in processing communications using a secure messaging protocol.

19. The system according to claim 1 wherein said at least one record is cryptographically protected.

20. A method to facilitate separate cardholder and authority access to resources controlled by a smart card comprising the steps of:
a. collecting biometric data from a cardholder associated with said smart card,
b. sending said biometric data to a server for processing,
c. generating a result from said processing,
d. querying a biometric database with said result,
e. retrieving in said server a secret associated with a matching record,
f. authenticating said cardholder to said smart card using said server secret,
g. allowing access to said resources.

21. The method according to claim 20 wherein said step f. includes the steps of:
a. generating a challenge by said smart card,
b. sending said challenge to said server,
c. generating a response to said challenge using said server secret,
d. sending said response to said smart card,
e. authenticating said response by said smart card.

22. The method according to claim 21 wherein said server secret is a cryptographic key compatible with an existing cryptographic key and algorithm operatively installed in said smart card.

23. The method according to claim 20 wherein said step f. includes the steps of:
a. sending said secret to said smart card,
b. comparing said secret to a previously stored secret in said smart card,
c. authenticating said secret by said smart card.

24. The method according to claim 20 wherein said server secret is a personal identification number unknown to said cardholder.

25. The method according to claim 20 wherein said biometric data includes a fingerprint, a retinal scan, an iris scan, a hand geometry scan, a face recognition scan, or a voice pattern scan.

26. The method according to claim 20 wherein said resources includes means for authenticating said smart card to said server.

27. The method according to claim 20 wherein step b. includes using a secure messaging protocol.

28. The method according to claim 21 wherein step b. includes using a secure messaging protocol.

29. The method according to claim 23 wherein step a. includes using a secure messaging protocol.
